(19) United States
(12) Patent Application Publication
(10) Pub. No.: US 2006/0220446 A1
(43) Pub. Date: Oct. 5, 2006

(54) Check valve for high-pressure fluid reservoir

(76) Inventors: Daniel W. Jensen, Oshkosh, WI (US); Scott Westpfahl, Oshkosh, WI (US); Kenneth R. Seymour II, Sheboygan, WI (US)

Correspondence Address: INTERNATIONAL ENGINE INTELLECTUAL PROPERTY COMPANY, 4201 WINFIELD ROAD, P.O. BOX 1488, WARRENVILLE, IL, 60555, US

(21) Appl. No.: 11/093,861

(22) Filed: Mar. 30, 2005

(51) Int. Cl. B60T 13/74

(52) U.S. Cl. 303/3; 303/10

(57) ABSTRACT

A system isolates fluid that enters a high-pressure fluid reservoir (116) from fluid in other components of an engine (100). The high-pressure fluid reservoir (116) has an entrance (120) in which a plug assembly (128) is disposed. A fluid source or case-to-head tube (114) is connected to the plug assembly (128). Fluid circulates from the case-to-head tube (114), through a supply conduit (130) formed by the plug assembly (128), and into the high-pressure fluid reservoir (116). A check valve (115) is disposed in the supply conduit (130). The check valve (115) essentially stops the flow of fluid from the high-pressure fluid reservoir (116) into the case-to-head tube (114) when the pressure of fluid in the case-to-head tube (114) is less than the pressure of fluid in the high-pressure fluid reservoir (116).

### FIELD OF THE INVENTION

This invention generally relates to fluid systems for internal combustion engines. More particularly, this invention relates to fluid systems in engines that have a check valve to prevent the backflow of fluid from a fluid reservoir to a fluid source.

### BACKGROUND OF THE INVENTION

Many engines have a hydraulic fuel injection system. Generally, the fuel injection system has a fuel injector for each cylinder. Some fuel injectors use high-pressure hydraulic fluid to increase the pressure of the fuel, while others directly inject high pressure fuel into the engine. Hydraulic fluid systems usually have a low-pressure pump that circulates the hydraulic fluid from a sump or main reservoir to a high-pressure pump. The hydraulic fluid may pass through an oil filter and an oil cooler prior to the high-pressure pump. High pressure fuel systems typically have a low-pressure pump that circulates fuel from a main reservoir or tank to a high-pressure pump. The fuel from the high pressure pump may pass through a filter and a fuel cooler before being accumulated in a high-pressure reservoir that feeds the injectors.

The high-pressure pump provides the fluid through tubing to one or more high-pressure rails or reservoirs adjacent to the fuel injectors. An engine with an in-line configuration may have one high-pressure rail adjacent to the single bank of cylinders. An engine with a “V” configuration may have two high-pressure reservoirs, each adjacent to separate banks of cylinders. The tubing may have one or more tubes or conduits, which may be rigid, flexible, or a combination thereof. The high-pressure pump usually has a pressure regulation valve or device to maintain a desired pressure of the fluid in the high-pressure reservoir during engine operation.

During operation, fluid from the high-pressure pump flows through a branch tube and lower tube section of the case-to-head tube to a check valve. When the pressure of the fluid in the lower tube section is greater the pressure of the fluid in the upper tube section, the fluid flows into the upper tube section through the check valve. Each case-to-head tube is usually made by precision machining or grinding. The inside diameters of the lower and upper tube sections are machined or ground to form various features of the check valve. The outside diameter of lower tube section and the inside diameter of the upper tube section also are machined or ground for the tube sections to fit together to form the case-to-head tube. Precision machining or grinding may increase the manufacturing cost of the case-to-head tubes.

Accordingly, there is a need for a more cost effective and less complex check valve for use in high-pressure reservoirs.

### SUMMARY

A backflow prevention system for fluid used in an engine is provided. The backflow prevention system isolates fluid that enters a high-pressure reservoir or rail from fluid in other components of the engine. The backflow prevention system essentially stops the backflow of fluid from the high-pressure reservoir to a fluid source, such as a case-to-head tube, connected to the high-pressure reservoir.

A system isolates fluid that enters a high-pressure fluid reservoir from fluid in other components of an engine. A plug assembly is disposed in an entrance of the high-pressure fluid reservoir. A fluid source or case-to-head tube is connected to the plug assembly. Fluid circulates from the case-to-head tube, through a supply conduit formed by the plug assembly, and into the high-pressure fluid reservoir. A check valve is disposed in the supply conduit. The check valve essentially stops the flow of fluid from the high-pressure fluid reservoir into the case-to-head tube when the pressure of fluid in the case-to-head tube is less than the pressure of fluid in the high-pressure fluid reservoir.

### BRIEF DESCRIPTION OF THE DRAWINGS

FIG. 1 is a block diagram of a backflow prevention system for fluid in an engine, in accordance with the invention.

FIG. 2 is a cutaway, side view of the connection between the fluid source and the high-pressure reservoir in the backflow prevention system of FIG. 1, in accordance with the invention.

FIG. 3 is a side view of the plug assembly in the high-pressure reservoir of FIG. 2, in accordance with the invention.

FIG. 4 is a cutaway, perspective view of the fluid source of FIG. 2, in accordance with the invention.

FIG. 5 is a cutaway, perspective view of the connection between the fluid source and the plug assembly of FIG. 2, in accordance with the invention.

FIG. 6 is a section view of the plug assembly of FIG. 3, in accordance with the invention.

### DETAILED DESCRIPTION OF A PREFERRED EMBODIMENT

A backflow prevention system for fluid used in an internal combustion engine is provided. The backflow prevention system isolates fluid that enters a high-pressure reservoir from fluid in other components of the engine. The backflow prevention system essentially stops the backflow of fluid from the high-pressure reservoir to a fluid source, for example a case-to-head tube, connected to the high-pressure reservoir.

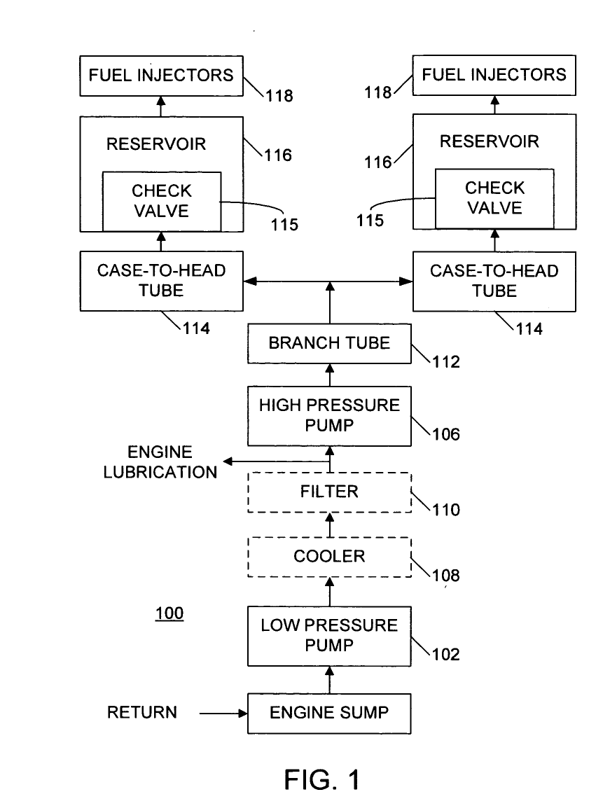

FIG. 1 is a block diagram or flow chart of a backflow prevention system 100 for fluid in an engine. The backflow prevention system 100 has a low-pressure pump 102 that circulates fluid from a sump 104 to a high-pressure pump 106. The fluid may be fuel, lubricating oil, actuating oil, a combination thereof, or another like fluid. The fluid may pass through an optional cooler 108 and/or an optional filter 110 prior to the high-pressure pump 106. A portion of the fluid may be diverted prior to the high-pressure pump 106 for engine lubrication in the case where the fluid is lubricating oil. The high-pressure pump 106 is the fluid source that circulates fluid through a branch tube 112, through one or more case-to-head tubes 114, through one or more check valves 115, and one or more high-pressure reservoirs 116. Each high-pressure reservoir 116 supplies fluid to one or more fuel injectors 118. Used or excess fluid returns to the engine sump 104.

Each high-pressure reservoir 116 may have a backflow prevention device, such as the check valve 115, disposed within an entrance to the high-pressure reservoir 116. The check valve 115 prevents fluid that has entered the high-pressure reservoir 116 from reentering the fluid source, shown in this case as the case-to-head tube 114. When the pressure of fluid in the case-to-head tube 114 is less than the pressure of fluid in the high-pressure reservoir 116, the check valve 115 essentially stops the flow of fluid from the high-pressure reservoir 116 into the case-to-head tube 114. While a particular configuration is shown, the backflow prevention system 100 may have other configurations including those with additional components.

The engine may have six or eight cylinders arranged in two banks having a vee configuration (not shown). The engine may have other numbers and arrangements of cylinders such as an in-line configuration and the like. The fuel injectors 118 are disposed adjacent to the cylinders.

The low-pressure pump 102 and the high-pressure pump 106 may be electrical, mechanical, a combination thereof, or the like. The low-pressure pump may increase the pressure of the fluid to about 50 psi (0.3 MPa). The high-pressure pump 106 may increase the pressure of the fluid to the range of about 500 psi (3 MPa) through about 4,500 psi (31 MPa). Other pressures of the fluid may be used. The high-pressure pump 106 may have a reservoir for holding fluid from the low-pressure pump 102.

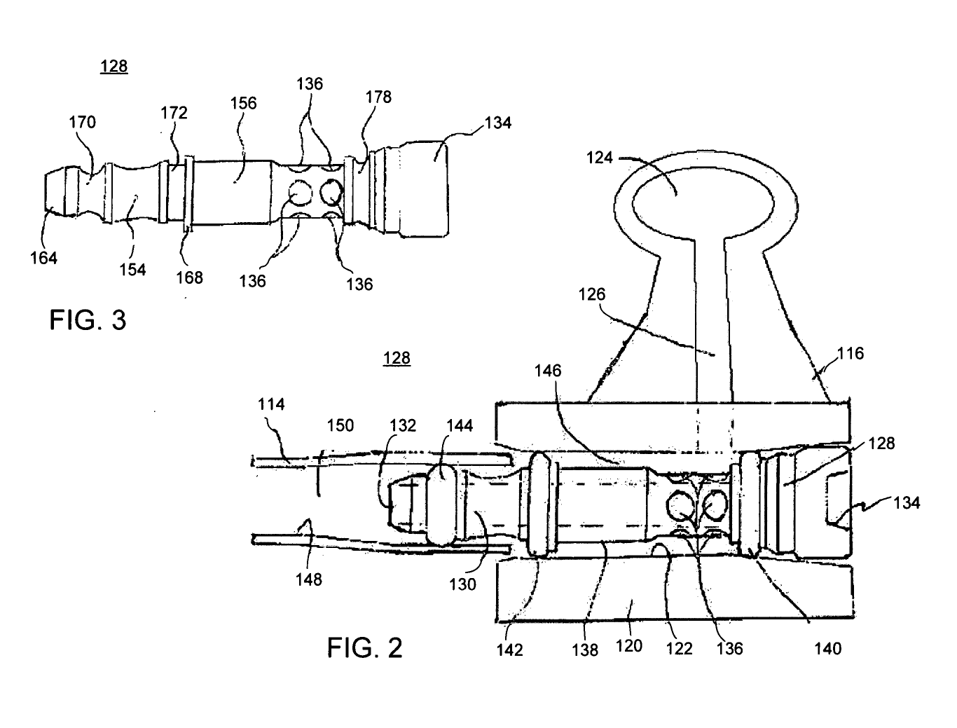

FIG. 2 is a view of the connection between the high-pressure reservoir 116 and the case-to-head tube 114. The high-pressure reservoir 116 has an inlet 120 that is open at both ends. The high-pressure reservoir 116 includes a fluid reservoir 124 and a fluid passageway 126. The fluid reservoir 124 may extend substantially along the length of the high-pressure reservoir 116 and may hold fluid for the fuel injectors. The fluid passageway 126 connects the entrance 120 to the reservoir 124. The high-pressure reservoir 116 may be made from machining or grinding a steel casting. The high-pressure reservoir 116 may be made from other materials and processes.

The high-pressure reservoir 116 has a plug assembly 128 disposed within the entrance 120 as shown in FIG. 3. The plug assembly 128 has a supply conduit 130 with an opening 132 at a first end. The plug assembly 128 has a plug end 134 at a second end. The plug assembly 128 has one or more outlet holes 136 between the opening 132 and the plug end 134. Each hole 136 extends from the supply conduit 130 to an outside plug surface 138 of the plug assembly 128. There may be eight holes 136 arranged on the circumference of the plug assembly 128. There may be other numbers and/or other arrangements of the holes 136.

The plug assembly 128 has an first o-ring 140, a second o-ring 142, and a third o-ring 144. The first o-ring 140 is disposed on the outside plug surface 138 between the plug end 134 and the holes 136. The second o-ring 142 is disposed on the outside plug surface 138 between the holes 136 and the opening 132. The third o-ring 144 is disposed on the outside plug surface 138 between the second o-ring 142 and the opening 132. The o-rings 140, 142, and 144 may be made from an elastomeric or like material.

When the plug assembly 128 is disposed in the entrance 120, the first o-ring 140, and the second o-ring 142 sealably engage the inside rail surface 122 on opposite sides of the fluid passageway 126. Sealably engage includes, for example, connections where little or no fluid passes. The inside rail surface 122, the outside plug surface 138, the first o-ring 140, and the second o-ring 142 define an entry chamber 146.

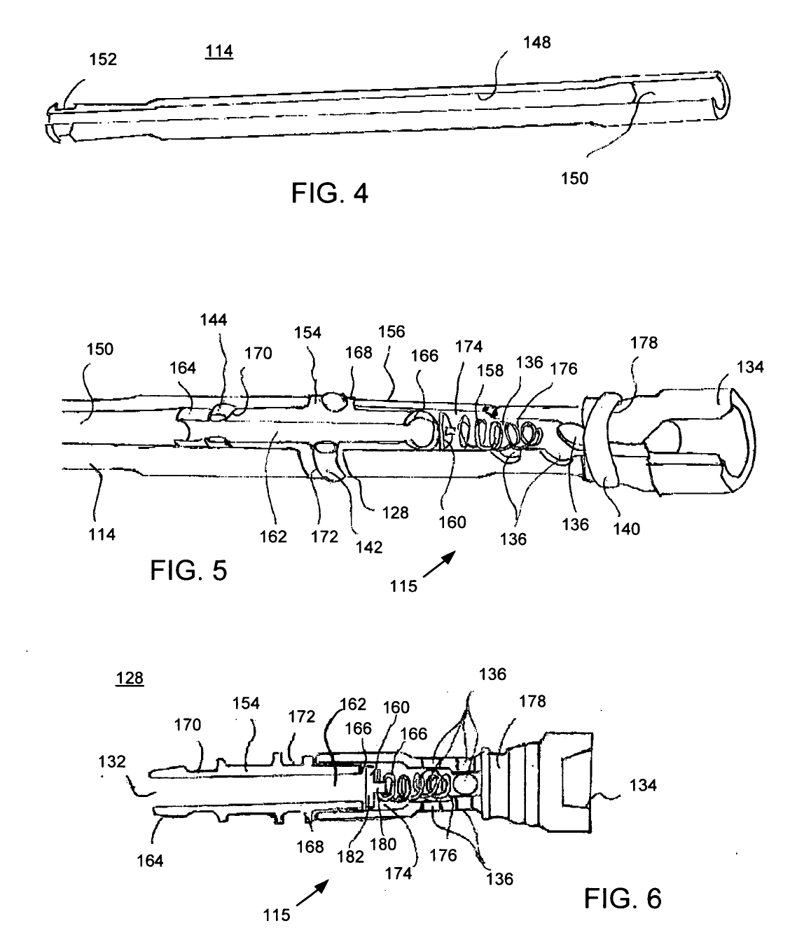

FIG. 4 is a cutaway, perspective view of the case-to-head tube 114, which has an inside tube surface 148 around a supply passageway 150 that is open at both ends. The case-to head tube 114 has a tube land 152 near one end. The tube land 152 is a groove or indentation extending around the circumference of the tube. An o-ring (not shown) is disposed on the tube land 152. When the case-to-head tube 114 is connected to the branch tube 112, the o-ring sealably engages the inside of the branch tube 112. The case-to-head tube 114 may advantageously be made from cold drawn or formed steel tubing with finish machining or grinding of the outside surface. A cold-drawn steel tube with finish machining or grinding has advantageously lower manufacturing costs than a steel tube with precision machining and grinding. The case-to-head tube 114 may be made using other materials and processes.

The case-to-head tube 114 operably connects to the plug assembly 128. When assembled, the plug assembly 128 extends into the supply passageway 150. The third o-ring 144 sealably engages the inside tube surface 148. The supply passageway 150 fluidly connects to the supply conduit 130.

During operation, fluid flows from the high-pressure pump 106, through the branch tube 112, through the case-to-head tube 114, and into the high-pressure reservoir 116. The fluid flows from the supply passageway 150 into the supply conduit 130 of the plug assembly 128. The fluid flows from the supply conduit 130, through the holes 136, and into the entry chamber 146 in the entrance 120. The fluid flows from the entry chamber 146, through the fluid passageway 126, and into the fluid reservoir 124. When the fluid pressure in the case-to-head tube 114 is less than the fluid pressure in the high-pressure reservoir 116, the plug assembly 128 has the check valve 115 in the supply conduit 130 that prevents the flow of fluid from the high-pressure reservoir 116 into the case-to-head tube 114.

FIG. 5 is a cutaway, perspective view of the connection between the case-to head tube 114 and the plug assembly 128. FIG. 6 is a section view of the plug assembly 128. The plug assembly 128 has a first plug section 156, an second plug section 154, a spring 158, and a poppet 160. The poppet 160 is an example of a valve element the check valve 115 may have. Different configurations for the valve element are also acceptable, for example a rigid or flexible flap, to replace the poppet 160 in the check valve 115. The first and second plug sections 154 and 156 may be made from machining or grinding steel castings, tubes, or a combination thereof. The first and second plug sections 154 and 156 may be made from other materials and processes.

The second plug section 154 has a channel 162 that is open at both ends. The channel 162 connects to the opening 132 formed in a tapered end 164 of the second plug section 154. The outside diameter of the second plug section 154 reduces toward the tapered end 164. The tapered end 164 may have a smaller outside diameter than the inside diameter of the case-to-head tube 114.

The second plug section 154 has a valve seat 166 on an end opposite the tapered end 164. The channel 162 extends from the opening 132 to the valve seat 166. The valve seat 166 is a surface or portion of the second plug section that touches the poppet 160 during operation of the backflow prevention system 100. The valve seat 166 may be cut, ground, and/or machined to improve the flatness of the surface. Improving the flatness includes, for example, forming a more perpendicular surface or a surface having an angle closer to about 90 degrees with the axis of the second plug section. The valve seat 166 may be cut, ground, and/or machined to form an even surface. The valve seat 166 may have essentially the same or a greater cross-section area as the case-to-head tube 114. The valve seat 166 may have other cross-section areas.

The second plug section 154 is arranged and constructed to be partially disposed inside the first plug section 156. The second plug section 154 has a stop 168 arranged and constructed to limit how far the second plug section 154 is disposed inside the first plug section 156. The stop 168 is a projection or larger diameter portion that extends radially from the second plug section 154. The second plug section 154 may advantageously have a plug land 170 near the opening 132 formed in the tapered end 164. The second plug section 154 may have a plug land 172 between the stop 168 and the plug land 170. The lands 170 and 172 are grooves or indentations extending along the circumference of the second plug section 154. When assembled, the third o-ring 144 is disposed on the plug land 170 and the second o-ring 142 is disposed on the plug land 172.

The first plug section 156 has a valve chamber 174 fluidly connected to a cavity 176. The valve chamber 174 and the cavity 176 are both part of the supply conduit 130. The valve chamber 174 is open at one end, which is opposite the plug end 134. The cavity 176 is disposed between the valve chamber 174 and the plug end 134. The cavity 176 may have a smaller diameter than the valve chamber 174. The cavity 176 may have other diameters and may advantageously be integrated with the valve chamber 174. The valve chamber 174 has a larger inside diameter than the outside diameter of the second plug section 154.

The first plug section 156 has the one or more outlet holes 136 between the valve chamber 174 and the plug end 134. Each hole 136 extends radially from the cavity 176 to the outside plug surface 138. There may be eight holes 136 arranged in pairs about 90 degrees from each other along a circumference of the plug assembly 128. There may be other numbers and/or other arrangements of the holes 136.

The first plug section 156 has a plug land 178 between the holes 136 and the plug end 134. The plug land 178 may advantageously be a groove or indentation extending along the circumference of the first plug section 156. When assembled, the first o-ring 140 is disposed on the plug land 178.

The spring 158 is a linear spring that may be made of metal wire or like material. The force biasing function of the spring 158 may be accomplished by another force biasing device, for example, a torque spring may be used in conjunction with a rigid flap attached to a hinge, or the elasticity of a material may be used for a flexible flap. The spring 158 may have an outside diameter that is smaller than the inside diameter of the cavity 176. The spring 158 may have other diameters.

The poppet 160 has a vertical guide 180 connected to a cylindrical section 182. The poppet 160 may have other configurations. The vertical guide 180 may have a smaller diameter than the inside diameter of the spring 158. The cylindrical section 182 may have a larger diameter than the inside diameter of the second plug section 154. The cylindrical section 182 may have a smaller diameter than the inside diameter of the first plug section 156. The cylindrical section 182 may have a diameter essentially equal to the outside diameter of the valve seat 166. The vertical guide 180 and cylindrical section 182 may have other diameters.

When assembled, the plug assembly 128 has the check valve 115 integrated within the supply conduit 130 and disposed in the valve chamber 174. The check valve 115 includes the spring 158, the poppet 160, and the valve seat 166. The supply conduit 130 includes the channel 162, the valve chamber 174, and the cavity 176. The spring 158 is disposed in the cavity 176 and extends into the valve chamber 174. The poppet 160 is disposed on the spring 158 with one end of the spring 158 substantially surrounding the vertical guide 180. The valve seat 166 on the second plug section 154 is disposed in the valve chamber 174 of the first plug section 156. The spring 158 biases the poppet 160 against the valve seat 166 inside the valve chamber 174.

During operation, fluid flows from the case-to-head tube 114, through the opening 132, and into the channel 162. When the resultant force on the poppet 160 due to the fluid pressure in the channel 162 exceeds the sum of the biasing force of the spring 158 and the resultant force on the poppet 160 due to the fluid pressure in the valve chamber 174, the poppet 160 is pushed into the valve chamber 174 away from the valve seat 166, and the check valve 115 opens. When the check valve 115 is open, fluid flows past the valve seat 166 and poppet 160, into the valve chamber 174, and into the cavity 176. The fluid flows from the cavity 176, through the outlet holes 136, and into the entry chamber 146 of the high-pressure reservoir 116. When the pressure of fluid in the channel 162 is less than the pressure of fluid in the valve chamber 174, the fluid in the valve chamber 174 closes the check valve 115 by pushing the poppet 160 against the valve seat 166.

The check valve 115 isolates the fluid that has entered the high-pressure reservoir 116 from fluid in other engine components. The check valve 115 prevents the flow of fluid from valve chamber 174 into the channel 162, thus preventing the flow of fluid from the high-pressure reservoir 116 into the fluid source or case-to-head tube 114.

When the check valve 115 is closed, the poppet 160 presses against and advantageously forms a seal with the valve seat 166 when the pressure of fluid in the channel 166 decreases below the pressure of the fluid in the valve chamber 174. The force pressing the poppet 160 against the valve seat 166 increases as the pressure of fluid in the channel 162 decreases below the pressure of the fluid in the valve chamber 174. The flatness of the valve seat 166 may be selected to reduce or eliminate leakage of fluid between the poppet 160 and the valve seat 166, thereby substantially eliminating flow from the high-pressure reservoir back to the fluid source. The cross-section area of the valve seat 166 may be selected to reduce or eliminate leakage of fluid between the poppet 160 and the valve seat 166.

The biasing force of the spring 158 may be selected to advantageously reduce a response time of the check valve 115. Response time includes the time between when the pressure of the fluid in the channel 162 becomes less than the pressure of the fluid in the valve chamber 174 and when the poppet 160 presses or seals against the valve seat 166. The check valve 115 is open but closing during the response time and fluid may flow from the valve chamber 174 into the channel 162. The biasing force of the spring 158 may be selected to decrease the response time, thus reducing the flow of fluid from the valve chamber 174 into the channel 162 during the response time. The biasing force of the spring 158 may be selected to essentially eliminate the response time, thus substantially stopping the flow of fluid from the valve chamber 174 into the channel 162 during the response time.

The fluid circulates from an engine sump or reservoir to a high-pressure pump and may contain solid particulates and/or other contaminants that may adversely affect the high-pressure pump. These solid particulates and/or contaminants may be cleaned or filtered from the fluid. The temperature of the fluid may be reduced in a cooler. The pressure of the fluid may be increased to about 50 psi (0.3 MPa). Other pressures may be used.

The fluid circulates from the high-pressure pump to a high-pressure reservoir. The pressure of the fluid may be increased into the range of about 500 psi (3 MPa) through about 4,500 psi (31 MPa). Other pressures may be used. The fluid in the high-pressure reservoir may be used to activate one or more fuel injectors to inject fuel into the cylinders of the engine.

Although the present invention is described with respect to a high-pressure fluid, the present invention is advantageously applicable to low-pressure fluids.

One advantage of the preferred embodiment is the reduction in cost and complexity in the manufacture and design of the case-to-head tube. With the check valve integrated with the plug assembly the complexity is removed from the case-to-head tube. Another advantage of the preferred embodiment is the improved reliability for assembly of the system. With the check valve integrated with the plug assembly, the installation of the plug assembly as well as the case-to-head tube does is advantageously simpler and more robust. An additional advantage of the preferred embodiment is the improved serviceability of the check valve. With the check valve integrated in the plug assembly, the entire assembly can be removed and reinstalled easily during service or replacement. Furthermore, the integration of the check valve with the plug assembly allows for improved and simpler testing of the check valve prior to installation on the engine.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes that come within the meaning and range of equivalency of the claims are to be embraced within their scope.

What is claimed is:

1. A system comprising:
a high-pressure fluid reservoir receiving fluid from a fluid source;
a check valve disposed in an entrance to the high-pressure fluid reservoir;
wherein the check valve substantially stops flow of fluid from the high-pressure fluid reservoir into the fluid source.

2. The system of claim 1, further comprising a plug disposed between the fluid reservoir and the fluid source, wherein the check valve is disposed in the plug.

3. The system of claim 1, wherein the check valve closes when pressure of fluid in the fluid source is less than pressure of fluid in the high-pressure fluid reservoir.

4. The system of claim 1, wherein the check valve includes a valve element, and wherein fluid in the fluid source pushes the valve element off a valve seat when an opening force is exerted on the valve element by pressure of fluid in the fluid source that exceeds a sum of a biasing force and a closing force exerted on the valve element by pressure of fluid in the high-pressure reservoir.

5. The system of claim 4, wherein the valve element is a poppet, and wherein the fluid in the high-pressure reservoir presses the poppet against the valve seat when pressure of fluid in the fluid source is less than pressure of fluid in the high-pressure reservoir.

6. A system for fluid comprising:
a high-pressure fluid reservoir having an entrance;
a plug assembly disposed in the entrance, wherein the plug assembly has a supply conduit with an opening at a first end and a plug end at a second end, wherein the plug assembly has at least one outlet hole between the opening and the plug end, wherein the at least one outlet hole extends from the supply conduit to an outside plug surface of the plug assembly;
a check valve disposed within the supply conduit of the plug assembly; and
a fluid source connected to the plug assembly, wherein the fluid source has a supply passageway.

7. The system of claim 6, wherein the high-pressure fluid reservoir includes a reservoir volume and a reservoir passageway, and wherein the reservoir passageway fluidly connects the reservoir volume and the entrance.

8. The system of claim 6, further comprising at least one of:
a first o-ring disposed on plug between the at least one outlet hole and the plug end, wherein the first o-ring sealably engages the entrance;
a second o-ring disposed on the plug between the at least one hole and the opening, wherein the second o-ring sealably engages the entrance; and
a third o-ring disposed on the plug between a second o-ring and the opening, wherein the third o-ring sealably engages the entrance.

9. The system of claim 6, wherein the plug assembly has at least four outlet holes.

10. The system of claim 6, wherein the check valve separates fluid in the high-pressure fluid reservoir from fluid in other engine components.

11. The system of claim 6, wherein the check valve substantially stops flow of fluid from the high-pressure fluid reservoir into the fluid source when the pressure of fluid in the fluid source is less than the pressure of fluid in the high-pressure fluid reservoir.

12. The system of claim 6, wherein the check valve includes a valve element, and wherein fluid in the fluid source pushes the valve element off a valve seat when an opening force is exerted on the valve element by pressure of fluid in the fluid source that exceeds a sum of a biasing force and a closing force exerted on the valve element by pressure of fluid in the high-pressure fluid reservoir.

13. A plug assembly for fluid comprising:
an first section having a valve chamber;
a check valve disposed in the valve chamber, wherein the check valve comprises a valve seat, a spring, and a poppet disposed on the spring, wherein the spring biases the poppet against the valve seat;
a second section connected to the first section, wherein the second section has an opening on one end and the valve seat on another end;
at least one fluid outlet hole formed in the first section and in fluid communication with the valve chamber.

14. The plug assembly of claim 13, wherein fluid in the second section pushes the poppet into the valve chamber when an opening force exerted on the poppet by the pressure of the fluid in the second section exceeds a sum of a biasing force and a closing force exerted on the valve element by the pressure of fluid in the valve chamber.

15. The plug assembly of claim 13, wherein fluid presses the poppet against the valve seat when pressure of fluid in the second section is less than pressure of fluid in the valve chamber.

16. The plug assembly of claim 13, further comprising a supply conduit extending from the opening in the second section to the valve seat.

17. The plug assembly of claim 13, wherein the check valve inhibits flow of fluid from the valve chamber into the second section when pressure of fluid in the second section is less than pressure of fluid in the valve chamber.

18. The plug assembly of claim 13, further comprising at least one o-ring disposed on the plug assembly.

19. The plug assembly of claim 13, wherein the second section is partially disposed inside the first section.

20. The plug assembly of claim 19, further comprising a stop disposed on the second section and arranged and constructed to limit how far the second section is disposed inside the first section.
